(19) United States
(12) Patent Application Publication
(10) Pub. No.: US 2025/0386384 A1
(43) Pub. Date: Dec. 18, 2025

(54) DYNAMIC PDU SESSION ESTABLISHMENT METHOD, APPARATUS, AND SYSTEM FOR ANYCAST SERVICE

(71) Applicant: FOUNDATION OF SOONGSIL UNIVERSITY-INDUSTRY COOPERATION, Seoul (KR)

(72) Inventor: Young Han KIM, Seoul (KR)

(21) Appl. No.: 19/197,597

(22) Filed: May 2, 2025

(30) Foreign Application Priority Data
Jun. 12, 2024 (KR) 10-2024-0076011

(51) Int. Cl. H04W 76/10; H04W 24/08; H04W 48/16; H04W 64/00

(52) U.S. Cl. CPC H04W 76/10; H04W 24/08; H04W 48/16; H04W 64/00

(57) ABSTRACT

A method of establishing a dynamic PUD session for an anycast service by means of an Anycast Application Function (AF) includes: subscribing to a PDU session establishment event exposure notification for traffic targeting an anycast IP address; receiving a user plane management event exposure notification message including a UE address and optional UE location information via a Network Exposure Function (NEF) from a Session Management Function (SMF) determining that an AF notification trigger has been satisfied through the anycast IP address in accordance with a PDU session establishment request for an anycast IP address-based service of UE; selecting an optimal Data Network Access Identifier (DNAI) for the requested PDU session on the basis of currently monitored network and computer metrics and the UE location information; and transmitting the selected DNAI and routing information to the NEF through a preset message.

### CROSS-REFERENCE TO RELATED APPLICATION

This application claims priority under 35 U.S.C. § 119 of Korean Patent Application No. 10-2024-0076011 filed on Jun. 12, 2024, the entire contents of which are incorporated herein by reference.

### BACKGROUND

### (a) Technical Field

The present disclosure relates to a dynamic PDU session establishment method, apparatus, and system for an anycast service, and more particularly, to a method of dynamically establishing a Protocol Data Unit (PDU) session in response to a request from each individual User Equipment (UE) for an anycast IP address-based service.

### (b) Background Art

An anycast service is a method that enables a specific service address to be used at different autonomous locations. A request from UE for an anycast service may be provided by one of multiple available service instances of the same service at different locations. Recently, anycast has become a widely used network implementation method. Some examples of use cases include high-availability services and Domain Name System (DNS) redundancy improvement.

Multi-Access Edge Computing (MEC) is a common implementation method for the locations of anycast service. Various service instances of the same anycast service can be distributed at various MEC sites. In the case of a specific anycast service request, a network selects one of MEC sites hosting the requested service instance and is responsible for setting a corresponding routing path.

The Application Function (AF) influence on traffic routing is a standardized procedure by European Telecommunications Standards Institute (ETSI 3GPP) that allows MEC to control the traffic routing path in a 5G network towards hosted services. A typical AF traffic influence request defines target traffic and routing information that is influenced by the target traffic. Further, an option to subscribe to user plane management events may also be included in a core network function.

FIG. 1 illustrates essential and important conditional parameters of an AF traffic influence request.

As illustrated in FIG. 1, the parameters of an AF traffic influence request include an AF Transaction Identifier, which distinguishes different AF traffic influence requests.

Further, traffic description defines target traffic to be influenced and can use a combination of Data Network Name (DNN), optional Single Network Slice Selection Assistance Information (S-NSSAI), and Application Identifier.

Target UE Identifier defines the type of UE targeted by the AF traffic influence request (individual, group, or all UE).

AF can subscribe to user plane management events from a Session Management Function (SMF) to update previously created traffic routing influence rules by specifying the information mentioned above to the optional elements.

When an AF traffic influence request is an event subscription-only event, two condition fields are not required. If not, the potential location of an application is provided through a list of Data Network Access Identifiers (DNAI). Corresponding N6 traffic routing information for each DNAI is also provided in the corresponding field.

The technical specification titled “Procedures for 5G System Standards (TS 23.502)” by ETSI 3GPP describes three different AF traffic influence procedures. These procedures can be classified into two types depending on procedure initiation conditions.

The first type of procedure is started by the AF. The AF can influence traffic routing for the session of an individual UE or multiple UEs (sessions not identified by UE address).

The second type of procedure is started by the SMF. Through this procedure, the AF can verify the application relocation feasibility for an ongoing session in response to a SMF's user plane management event exposure notification. However, both procedures have drawbacks when they are applied to an anycast service scenario.

Regarding the AF initiation procedure type, FIG. 2 illustrates the AF traffic influence of ETSI 3GPP for traffic routing procedures targeting individual or multiple UEs.

The AF creates a traffic influence request and provides it to a core network function through a Network Exposure Function (NEF). Further, the information included in the AF traffic influence request is configured as policy rules in a Policy Control Function (PCF). In accordance with the AF traffic influence request targeting individual or multiple UEs, the NEF connects to the PCF through a Unified Data Repository (UDR) or a Binding Support Function (BSF).

The Session Management Function (SMF) sets corresponding session routing information for the service on the basis of the influenced PCF rules.

The current AF traffic influence procedure is a static influenced method.

Creation or update of traffic influence rules is started by the AF. When a UE service request is transmitted, it is routed in accordance with currently configured rules.

These two procedures are initiated by the AF. The AF can periodically update the traffic influence rules, but these rules are static and cannot be dynamically changed in accordance with a UE request.

In an anycast service routing scenario, there are multiple candidate service instances in different locations, and there are service instances that change in real time. A routing path should be determined not on the basis of previously configured static traffic influence rules, but on the basis of the current service functions at the moment of each UE request.

With respect to the SMF-initiated procedure type, the AF traffic influence procedure is referred to as a user plane management event exposure notification. Through this procedure, the AF can verify the application relocation feasibility when the user plane path is changed.

FIG. 3 is a diagram illustrating currently standardized steps of the SMF-initiated procedure type.

Each time a change in the user plane path occurs, the SMF selects a new service instance location (indicated by a DNAI) on the basis of preconfigured static traffic influence rules from the AF. Then, the SMF sends new DNAI and UE information to the AF via a user plane management event exposure notification. The AF responds to an event exposure notification of the SMF through an application relocation feasibility decision. When an application is not ready to be provided at a new location, the AF requests the SMF to maintain the previous user plane path for the previous service instance location. If not, the AF verifies the relocation and the SMF can configure a new user plane path on the basis of the traffic routing information previously configured by the AF. When the service reachability information is changed (such as N6 information, buffering requirements, or edge application server IP replacement), the AF can update the previous AF traffic influence rules.

The AF traffic influence procedure triggered by a user plane management event exposure notification supports only application relocation use cases.

FIG. 4 illustrates defined elements of an AppRelocationInfo message used by the AF to respond to a user plane management event exposure notification from the SMF.

The response message provides only an application relocation success status and optional traffic routing change information. A next optional AF traffic influence update step is used only to update a possible service reachability information change.

This procedure does not provide a function of changing a DNAI every time the AF receives user plane management event exposure. Meanwhile, in an anycast service scenario, every time a PDU session establishment request for the anycast service is triggered, an AF should be able to influence an SMF to select an optimal service instance location on the basis of the currently available service instance provisioning function.

### SUMMARY OF THE DISCLOSURE

In order to solve the problems of the related art described above, the present disclosure provides a dynamic PDU session establishment method, apparatus, and system for an anycast service that enables selection of an optimal anycast service instance from available serving instances on the basis of a current network, a service instance network, and a computing status in service traffic steering.

In order to achieve the object described above, according to an embodiment of the present disclosure, as a dynamic PDU session establishment method for an anycast service, there is provided a dynamic PDU session establishment method, including: subscribing to a PDU session establishment event exposure notification for traffic targeting an anycast IP address by means of an Anycast Application Function (AF); determining that an AF notification trigger has been satisfied through the anycast IP address, and transmitting a user plane management event exposure notification message including a UE address and optional UE location information to the anycast AF via a Network Exposure Function (NEF) by means of a Session Management Function (SMF) when there is a PDU session establishment request for an anycast IP address-based service of UE; selecting an optimal Data Network Access Identifier (DNAI) for the requested PDU session on the basis of currently monitored network and computer metrics and the UE location information by means of the anycast AF; transmitting the selected DNAI and routing information to the NEF through a preset message by means of the anycast AF; and completing PDU session establishment by setting a UPF corresponding to the selected DNAI by means of the SMF.

The anycast AF periodically may collect network metrics (network status information) monitored in a user plane network and service computing metrics (computing resource status information) at all controlled available service locations, and register distribution status of service instances for the anycast service.

The network metrics may include latency and bandwidth information collected by monitoring a mobile underlay network, and the computing metrics may include CPU, GPU, and memory usage statuses, and a queue status of service instances of each of a plurality of Multi-Access Edge Computings (MEC) provided for the anycast service.

The SMF may transmit the UE address and the optional UE location information to the anycast AF through a Nnef_TrafficInfluence_Notify message.

The anycast AF may respond with a Nnef_TrafficInfluence_AnycastLocationInfo message to the user plane management event notification message.

The Nnef_TrafficInfluence_AnycastLocationInfo message may include an AF transaction ID, identification information of the selected DNAI, N6 traffic routing information corresponding to the selected DNAI, and optional uplink traffic buffering requirements.

The anycast AF may dynamically change a service instance location of a session through an AF traffic influence procedure on the basis of metrics collected in real time during an ongoing PDU session.

The anycast AF may transmit a Nnef_TrafficInfluence_Create request message to the NEF when it is required to dynamically change the service instance location.

The Nnef_TrafficInfluence_Create request message may include an AF transaction ID, an anycast IP address, UE address, a selected DNAI, corresponding N6 traffic routing information of the selected DNAI, and DNAI change type information.

According to another aspect of the present disclosure, a method of establishing a dynamic PUD session for an anycast service by means of an Anycast Application Function (AF), the method including: subscribing to a PDU session establishment event exposure notification for traffic targeting an anycast IP address; receiving a user plane management event exposure notification message including a UE address and optional UE location information via a Network Exposure Function (NEF) from a Session Management Function (SMF) determining that an AF notification trigger has been satisfied through the anycast IP address in accordance with a PDU session establishment request for an anycast IP address-based service of UE; selecting an optimal Data Network Access Identifier (DNAI) for the requested PDU session on the basis of currently monitored network and computer metrics and the UE location information; and transmitting the selected DNAI and routing information to the NEF through a preset message, wherein the SMF completes PDU session establishment by setting a UPF corresponding to the selected DNAI.

According to another aspect of the present disclosure, as an Anycast Application Function (AF) apparatus for an anycast service,
there is provided an anycast AF apparatus, including: a network metric agent collecting network metrics related to a mobile underlay network; a service repository managing registration and availability of anycast service instances for all Multi-Access Edge Computings (MEC) under control; a computing metric agent collecting computing metrics of all MEC servers under control; and a DNAI selector transmitting an AF traffic influence request to a core network function and selecting an optimal Data Network Access Identifier (DNAI) for a requested PDU session on the basis of currently monitored network and computing metrics and location information of UE requesting establishment of the PDU session for an anycast IP address-based service, in response to a user plane management event exposure notification from the core network function in the case of subscribing to a PDU session establishment event exposure notification for traffic targeting an anycast IP address, wherein the DNAI selector selects the optimal DNAI when receiving a user plane management event exposure notification message including a UE address and optional UE location information from the core network function determining that an AF notification trigger has been satisfied through the anycast IP address.

According to another aspect of the present disclosure, as UE for providing an anycast service, there is provided a UE, including; a wireless transceiver for transmitting and receiving wireless signals; a memory storing program instructions; and a processor executing the program instructions and controlling the transceiver, wherein the processor transmits a PDU session establishment request signal for an anycast IP address-based service by connecting to a mobile underlay network through the transceiver, and performs control such that an Anycast Application Function (AF) subscribes to a PDU session establishment event exposure notification for traffic targeting an anycast IP address, a Session Management Function (SMF) determines that an AF notification trigger is satisfied via the anycast IP address and transmits a user plane management event exposure notification message including a UE address and optional UE location information to the anycast AF through a Network Exposure Function (NEF), the anycast AF selects an optimal Data Network Access Identifier (DNAI) for the requested PDU session on the basis of currently monitored network and computing metrics and the UE location information, the anycast AF transmits the selected DNAI and routing information to the NEF via a preset message, and packets are transmitted and received with a Multi-Access Edge Computing (MEC) corresponding to the DNAI through the transceiver when the SMF completes PDU session establishment by setting a UPF corresponding to the selected DNAI.

According to the present disclosure, when there is a PDU session establishment request for an anycast service including an anycast IP address of UE, an SMF determines that an AF notification has been satisfied through the anycast IP address, and transmits an event exposure notification including a UE address and UE location information to a preset AF via an NEF, and the AF selects an optimal anycast service instance among available serving instances on the basis of a current network and the computing ability of service instances, so that there is the advantage in that it is possible to perform dynamic PDU session establishment.

### BRIEF DESCRIPTION OF THE DRAWINGS

FIG. 1 illustrates essential and important conditional parameters of an AF traffic influence request.

FIG. 2 is a diagram showing the AF traffic influence of ETSI 3GPP for traffic routing procedures targeting individual or multiple UEs.

FIG. 3 is a diagram showing currently standardized steps of an SMF-initiated procedure type.

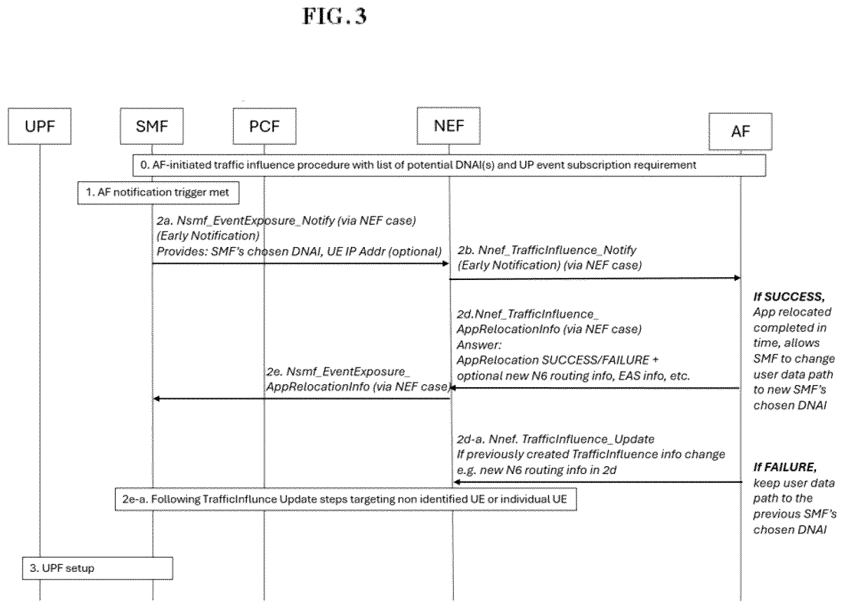

FIG. 4 illustrates defined elements of an AppRelocationInfo message used by the AF to respond to a user plane management event exposure notification from the SMF.

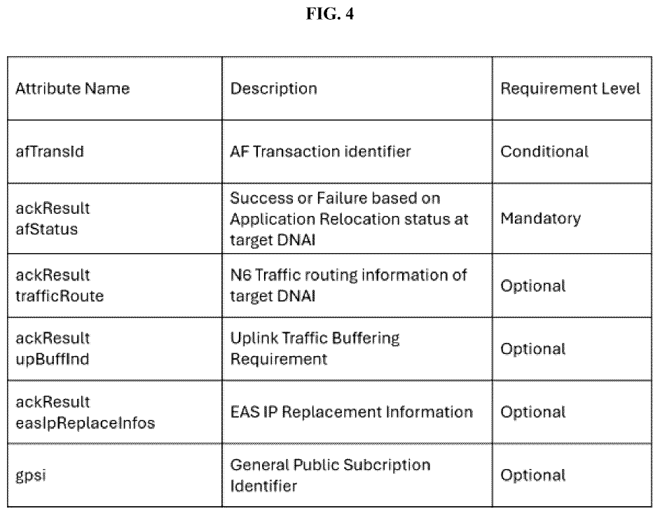

FIG. 5A is a diagram showing an anycast service traffic steering environment according to a preferred embodiment of the present disclosure.

FIG. 5B illustrates the relationship between subcomponents of an anycast AF and other components according to the present embodiment.

FIG. 6A is a diagram showing a dynamic PDU session establishment procedure for each UE anycast service request in a mobile network.

FIG. 6B describes attributes of an AF traffic influence request for user plane management event subscription.

FIG. 6C is a diagram showing the detailed structure of a Nnef_TrafficInfluence_Notify message.

FIG. 6D is a diagram showing the detailed structure of a Nnef_TrafficInfluence_AnycastLocationInfo message.

FIG. 6E is a diagram showing the detailed structure of a Nnef_TrafficInfluence_Create request message.

FIG. 7 is a diagram showing a dynamic PDU session establishment process for an anycast service according to the present embodiment.

FIG. 8 is a diagram showing another exemplary scenario applying the method according to the present embodiment.

FIG. 9 is a diagram illustrating a dynamic PDU session establishment procedure for an anycast service in the case of UE mobility.

FIG. 10 is a diagram showing the detailed configuration of user equipment according to the present embodiment.

### DETAILED DESCRIPTION

The present disclosure may be modified in various ways and implemented by various embodiments, so that specific embodiments are exemplified in the drawings and will be described in detail herein. However, it is to be understood that the present disclosure is not limited to the specific exemplary embodiments, but includes all modifications, equivalents, and substitutions included in the spirit and the scope of the present disclosure.

The terms used in this specification are used only in order to describe specific embodiments rather than limiting the present disclosure. Singular forms are intended to include plural forms unless the context clearly indicates otherwise. It is to be understood that the terms “comprises” or “have” used in this specification specify the presence of stated features, numerals, steps, operations, components, parts, or a combination thereof, but do not preclude the possibility of presence or addition of one or more other features, numerals, steps, operations, components, parts, or a combination thereof.

Further, the components of embodiments described with reference to each drawing are not limited only to corresponding embodiments and may be implemented to be included in other embodiments within the range of the spirit of the present disclosure, and it is also apparent that even though separate descriptions are omitted, a plurality of embodiments may be integrated and re-implemented as a single embodiment.

Further, in description of the accompanying drawing, same components are given the same or relevant reference numerals regardless of the figure numbers and redundant descriptions thereof will be omitted. In describing the present disclosure, when it is determined that a detailed description of related known technologies may unnecessarily obscure the gist of the present disclosure, the detailed description thereof will be omitted.

The present embodiment is to solve the problem of anycast service traffic steering in a mobile network.

An anycast service represents multiple service instances at multiple locations using a single address (e.g., an IP address). A UE request for an anycast service is provided by one of the available anycast service instances. In general, this implementation concept is used for services that require a high availability function. To meet this requirement, not only is a sufficient number of service instances required, but also a network solution that dynamically steers traffic among different service instances is necessary. It is possible to help prevent issues that may affect service experience and quality, such as a single service instance handling more requests than its capacity.

In the present embodiment, the dynamic traffic steering requirement is defined as the ability to select an optimal anycast service instance among available service instances on the basis of an UE request, a current network and computing capabilities of service instances. The routing path for various UE requests may differ and may be dynamically changed over time.

To address the requirements for anycast service traffic steering in a mobile network, the present embodiment proposes a dynamic PDU session establishment method based on and enhancing the current AF traffic influence of ETSI 3GPP on a traffic routing procedure.

The present embodiment includes a specialized AF (hereafter, referred to as an anycast AF) that is responsible for dynamically selecting an optimal service instance among available service instances for each individual UE request targeting a specific anycast service. The anycast AF according to the present embodiment periodically collects network metrics (network status information) monitored in a user plane network and service computing metrics (computing resource status information) at all controlled available service locations.

A distribution status of service instances is also registered in the anycast AF according to the present embodiment.

The present embodiment proposes a dynamic PDU session establishment procedure for an anycast service on the basis of an AF traffic influence policy.

The anycast AF first subscribes to a PDU session establishment event exposure notification for traffic targeting a specific anycast IP address. Then, for each PDU session establishment request, the anycast AF selects an optimal service instance on the basis of UE information provided by the SMF and the currently monitored network and computing metrics, and responds to the SMF with the selected service instance location and routing information for PDU session establishment. During an ongoing PDU session, the anycast AF may dynamically change the service instance location of the session through the AF traffic influence procedure on the basis of real-time metrics.

Hereafter, the dynamic PDU session establishment process according to the present embodiment is described in detail with reference to drawings.

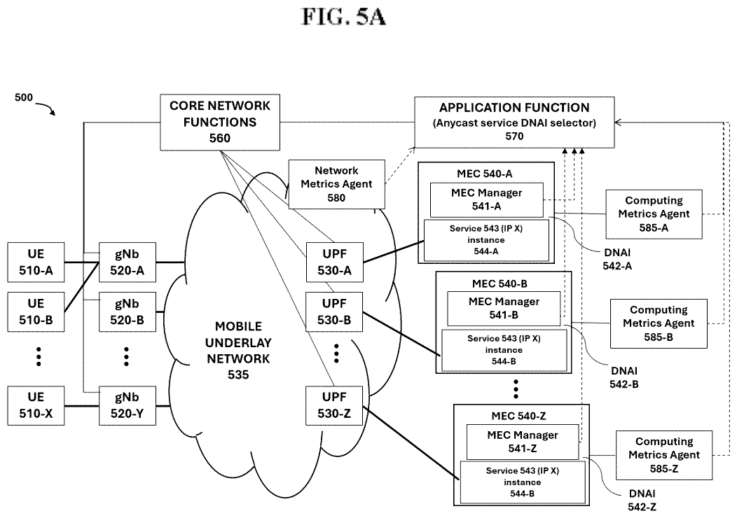

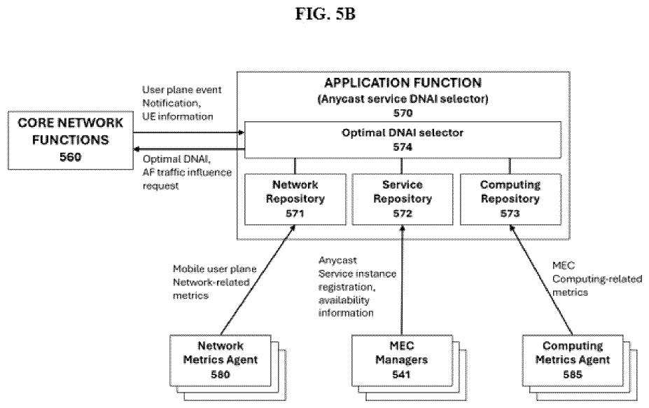

FIG. 5A is a diagram showing an anycast service traffic steering environment according to a preferred embodiment of the present disclosure.

As shown in FIG. 5A, an anycast service traffic steering environment 500 according to the present embodiment may include UEs 510-A to 510-X (individually referred to as UE 510), and gNodeB base stations 520-A to 520-Y (individually referred to as gNB 520).

Further, the anycast service traffic steering environment 500 includes a mobile underlay network 535 including multiple user plane functions 530-A to 530-Z (individually referred to as UPF 530), multiple MEC servers 540-A to 540-Z (individually referred to as MEC 540), MEC managers 541-A to 541-Z for the corresponding MEC servers (individually referred to MEC manager 541), DNAI identifying MEC server locations 542-A to 542-Z (individually referred to as DNAI 542), multiple anycast services 543, corresponding hosting service instances of exemplary anycast services 544-A to 544-Z (individually referred to as anycast service 543 and service instance 544), computing metric agents 585-A to 585-Z of each MEC (individually referred to as computing metric agent 585), a network metric agent 580, core network functions 560, and an anycast service DNAI selector AF 570 (hereafter referred to as anycast AF).

The UE 510 includes any wireless device used by an end user to access the mobile underlay network 535.

The UE 510 includes mobile devices such as a smartphone, a tablet, a laptop, and a wearable device. The UE 510 may be configured and installed with various types of implementation software for application clients of the anycast service. The UE 510 requests a specified anycast service 543 through the mobile underlay network 535 using an application client of the anycast service.

The gNBs 520 enable the UE 510 to access the specified anycast service 543 through the mobile underlay network 535.

Multiple UEs 510 can connect to the same or different gNBs 520 simultaneously. The UE 510 can move between different gNBs 520. When the UE 510 is connected to the gNB 520, the core network functions 560 can receive UE location information through the connected gNB 520.

The mobile underlay network 535 provides user plane connectivity between the gNB 520 and the MEC 540.

When the UE 510 requests a specified anycast service 543, the core network function 560 configures and sets up a user plane path in the mobile underlay network 535. This is hosted in different MECs 540. The user plane path from the UE 510 to each MEC 540 is anchored by a separate UPF 530 in the mobile underlay network 535.

The core network function 560 includes a network function in a control plane of the 5G mobile communication network defined by ETSI 3GPP. The core network function according to this embodiment 560 includes an Access and Mobility Management Function (AMF), an SMF, a PCF, a UDR, a NEF, and a BSF.

In an anycast service traffic steering scenario, UE location information is collected through communication between the AMF and the gNB 520. The SMF establishes a PDU session between the UE 510 and the data network (DN) for the anycast service and manages the session information. The PCF provides traffic steering rules for the PDU session that is controlled by the SMF. The UDR stores traffic influence information provided by the AF 570. The NEF performs session information exposure to the AF, and allows the AF 570 to provide traffic influence information to the core network function 560. By using the BSF, the AF 570 can search for a specific PCF that controls the session of the individual UE 510.

The MEC 540 is various computing servers capable of hosting services at the network edge closer to the end user.

In the implementation environment of the method described in the specification, the MEC 540 can be distributed on the basis of a distributed mobile network connection model defined in Technical Specification 23.548 of ETSI 3GPP.

Each MEC 540 may be regarded as a data network and may be anchored by a separate UPF 530. Each MEC 540 may be distributed at different locations of the network edge.

The location of each MEC 540 may be indicated by a separate DNAI 542. The service disposition lifecycle and status in each MEC are controlled and managed by the MEC manager 541. Each MEC 540 can dispose multiple standard address services and anycast IP address services.

In the exemplary environment 500 described in the specification, for simplicity, only a single anycast service 543 with anycast service IP X is exemplified as a representative of the anycast service disposition scenario. Different anycast services are represented by unique anycast IP addresses. The application client of the UE 510 is assumed to be pre-configured with a unique anycast IP address. The MEC manager can distribute one or more service instances 544 of a predetermined anycast service 543.

The network metric agent 580 performs monitoring of the mobile underlay network 535 and collects network-related metrics such as latency, bandwidth, and the like.

The computing metric agent 585 performs monitoring of each MEC 540 and collects computing-related metrics such as CPU, GPU, and memory usage statuses, and a queue status of service instances.

Both types of metric agents 580 and 585 can periodically monitor, collect, and update metrics. The network metric agent 580 and the computing metric agent 585 can use any kind of metric collection algorithm or mechanism and collect required metrics.

In the anycast dynamic PDU session establishment according to the present embodiment, only a general architecture is described and it does not limit the implementation options for metric collection.

The anycast AF 570 according to the present embodiment is designated for a anycast service deployment scenario.

FIG. 5B illustrates the relationship between subcomponents of an anycast AF and other components according to the present embodiment.

The anycast AF 570 according to the present embodiment can include a network repository 571, a service repository 572, a computing repository 573, and an optimal DNAI selector 574.

The network repository 571 can collect metrics related to the mobile underlay network 535 from the network metric agent 580.

The service repository 572 manages the registration and availability of the anycast service instances for all MECs 540 under the control of the anycast AF 570.

The computing repository 573 can collect computing-related metrics of all MEC servers under the control of the anycast AF 570 from the corresponding computing metric agent 585.

The optimal DNAI selector 574 can respond to a user plane management event exposure notification from the core network function 560. The optimal DNAI selector 574 can aggregate UE information provided from an event exposure notification of the core network function 560, currently requested anycast service instance availability information, and computing information from the current network and a corresponding repository to select an optimal DNAI for the anycast service PDU session establishment request.

The information collection and optimal DNAI selection algorithm of the optimal DNAI selector 574 in the present embodiment are not limited to a specific algorithm. The optimal DNAI selector 574 is a subcomponent of the anycast AF 570 that can send traffic influence requests to the core network function 560.

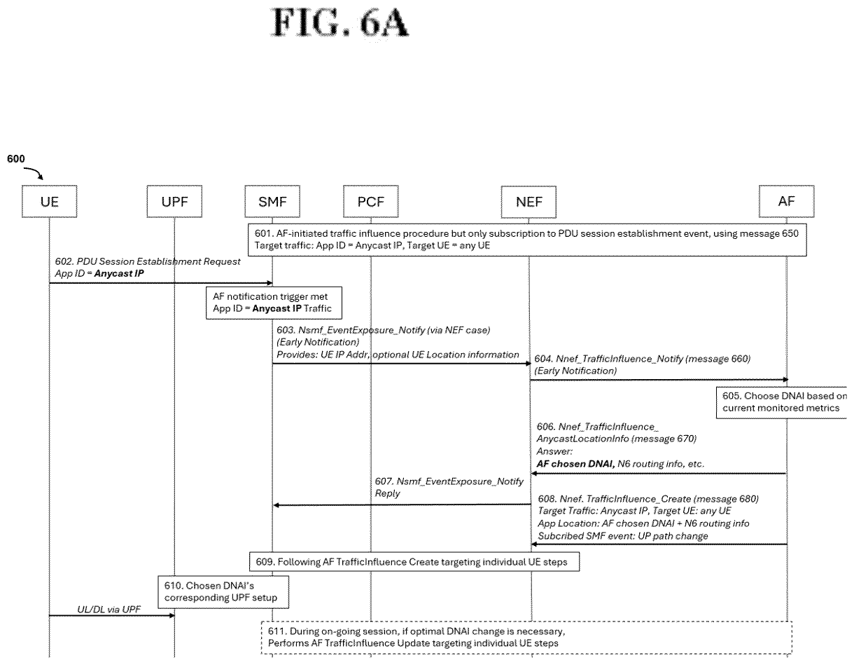

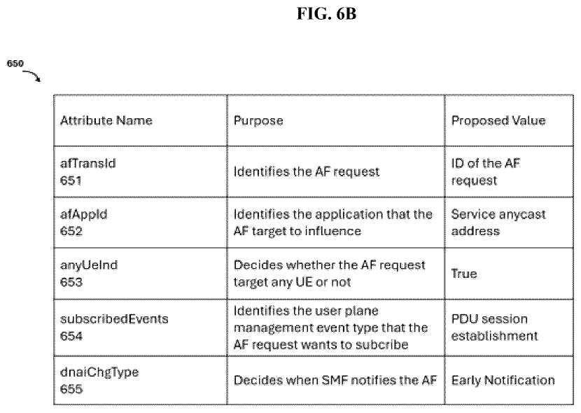

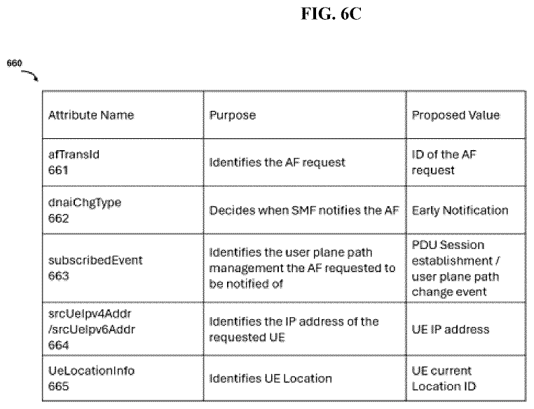

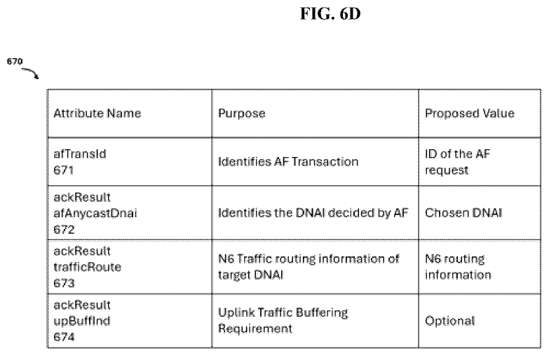

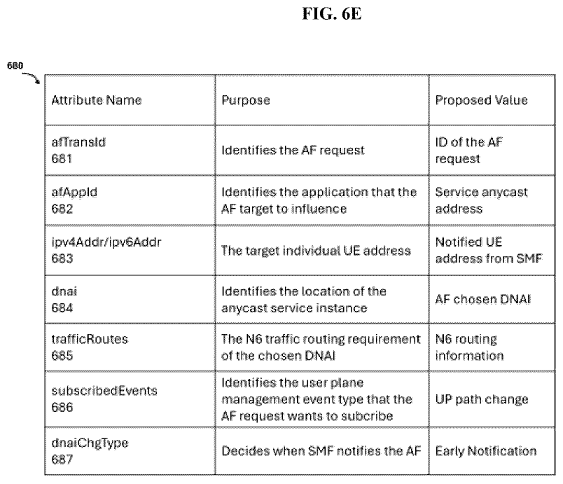

FIG. 6A is a diagram showing a dynamic PDU session establishment procedure for each UE anycast service request in a mobile network.

Through the procedure of FIG. 6A, the SMF of a mobile network can configure the PDU session toward the optimal service instance location for the anycast service request (indicated by a DNAI) on the basis of the AF traffic influence request for the anycast service.

In an anycast IP address-based service request, various DNAIs can be dynamically configured for various UE requests.

Referring to FIG. 6A, before a anycast IP address-based service request of the UE 510, the anycast AF 570 starts the AF traffic influence request to the core network function 560 using the message of FIG. 6B.

The AF traffic influence request targets any UE traffic of the specified anycast service 543. Further, the AF traffic influence request is initiated only when the anycast AF 570 subscribes to a user plane management event exposure notification. The AF traffic influence request requests the SMF to send a notification for the PDU session establishment request of any UE 510 targeting the specified anycast service 543.

FIG. 6B describes attributes of an AF traffic influence request for user plane management event subscription.

The AF traffic influence request 650 includes four attributes of AF traffic influence request's standard data model defined in ETSI 3GPP 29.522.

An afTransId attribute 651 defines a transaction ID of the AF traffic influence request. An afAppId attribute 652 defines target traffic description of the AF traffic influence request 650.

In the case of an anycast service scenario, the service anycast IP address is used as the target traffic description.

An anyUeInd attribute 653 defines the AF traffic influence request 650 targeting any UE traffic that satisfies the traffic description of the afAppId attribute 652.

A subscribedEvents attribute 654 defines the AF traffic influence request 650 that subscribes to a PDU session establishment event exposure notification from the SMF. A dnaiChgType attribute 655 defines that this is an early notification type.

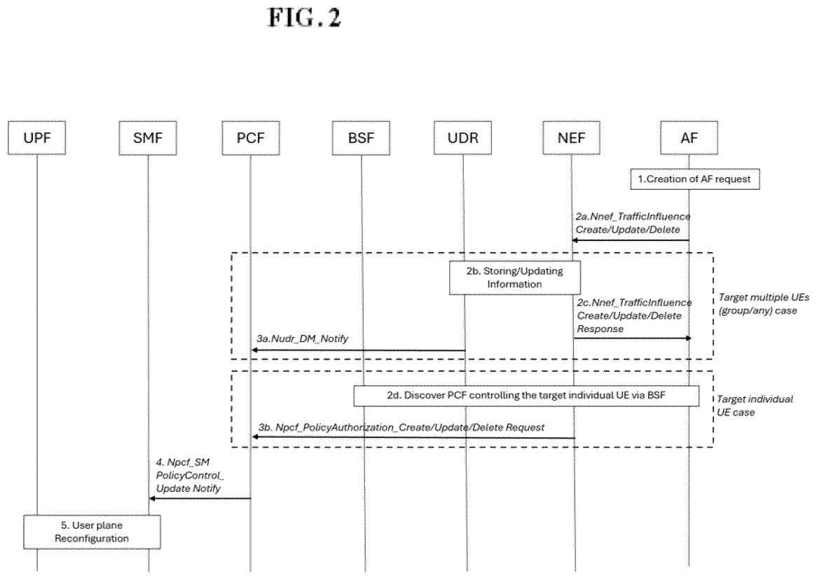

The AF traffic influence request 650 is processed in accordance with a standard AF traffic influence procedure targeting multiple UEs in FIG. 2.

Referring to FIG. 2, the NEF receives the AF traffic influence request 650 from the AF, stores the request information in the UDR, and then responds back to the AF. The UDR notifies the PCF of the new AF traffic influence information. The PCF updates the SMF with the new policy rules. Then, the SMF can send a PDU session establishment event exposure notification to the anycast AF 570 whenever any UE 510 requests a predetermined anycast service 543

As described above, step 602 in FIG. 6A is performed after the completion of the AF traffic influence procedure.

Referring again to FIG. 6A, whenever the SMF receives a PDU session establishment request (step 602) targeting the application ID (the anycast IP address of the anycast service 543) of the predetermined anycast service 543, the anycast AF alarm trigger is satisfied at the SMF.

The SMF sends a PDU session establishment notification to the anycast AF 570 through the NEF, along with an UE address and optional location information.

In step 603, the SMF transmits a Nsmf_EventExposure_Notify message, which is a user plane management event exposure notification message, to the NEF.

In step 604, the NEF delivers this information to the anycast AF 570 via a Nnef_TrafficInfluence_Notify message 660.

FIG. 6C is a diagram showing the detailed structure of a Nnef_TrafficInfluence_Notify message.

Compared to the message data model defined in ETSI 3GPP Technical Specification 29.522, the Nnef_TrafficInfluence_Notify message 660 in FIG. 6C includes a new optional attribute, UeLocationInfo, for UE location information. The anycast AF 570 can use optional UE location information for DNAI selection. Other attributes are ETSI standard attributes.

An AF transaction ID is used for the afTransId attribute. “Early Notification” is used for the dnaiChgType attribute 662. PDU session establishment is an event type subscribed in the subscribedEvent attribute 663.

The IP address of the UE 510 is included in the srcUelpv4Addr or srcUeIpv6Addr, depending on the type.

After receiving the Nnef_TrafficInfluence_Notify message 660 from the SMF, the anycast AF 570 selects an optimal DNAI for the notified PDU session in step 605.

The anycast AF 570 can use the current anycast service instance availability and mobile underlay network information. The anycast AF selects an optimal DNAI on the basis of the metrics collected from each of the repositories 571, 572, and 573 of the anycast AF and the UE location information provided in the Nnef_TrafficInfluence_Notify message 660. Any selection algorithm can be implemented in the optimal DNAI selector 574 of the anycast AF. The issue of the selection algorithm is not within the scope of the present disclosure.

In step 606, the anycast AF 570 responds with a Nnef_TrafficInfluence_AnycastLocationInfo message 670 to the user plane management event notification message 660 from the NEF. This is a newly defined message for an anycast service scenario compared to the current ETSI 3GPP standard.

FIG. 6D is a diagram showing the detailed structure of a Nnef_TrafficInfluence_AnycastLocationInfo message.

Referring to FIG. 6D, an afTransId attribute 671 is the AF transaction ID.

An ackResult_afAnycastDnai attribute 672 includes a DNAI selected by the anycast AF 570. The ackResult_trafficRoute attribute 673 includes corresponding N6 traffic routing information for the selected DNAI. An ackResult_upBuffInd attribute 674 is an optional uplink traffic buffering requirement. In step 607, the NEF delivers the response information in the Nnef_TrafficInfluence_AnycastLocationInfo message 670 to the SMF.

In step 608, the anycast AF 570 creates a new AF traffic influence request targeting the individual UE address provided in the SMF's event exposure notification message 660 and transmits the Nnef_TrafficInfluence_Create request message to the NEF.

FIG. 6E is a diagram showing the detailed structure of a Nnef_TrafficInfluence_Create request message.

A Nnef_TrafficInfluence_Create request message 680 uses the ETSI 3GPP standard attributes for the Nnef_TrafficInfluence_Create request. An afTransId attribute 681 is an AF transaction ID. An afAddpID attribute 682 is a requested service anycast IP address.

An ipv4Addr or ipv6Addr attribute 683 is a UE address received from the SMF event exposure notification message 660. A dnai attribute 684 is a DNAI selected by the anycast AF 570.

A TrafficRoutes attribute 685 is corresponding N6 traffic routing information of the selected DNAI. A subscribedEvents field 686 indicates that the AF is required to respond to a user plane path change event of the UE specified in 683. A DnaiChgType attribute 687 indicates that the SMF informs the AF of a user plane path change event using an early notification method.

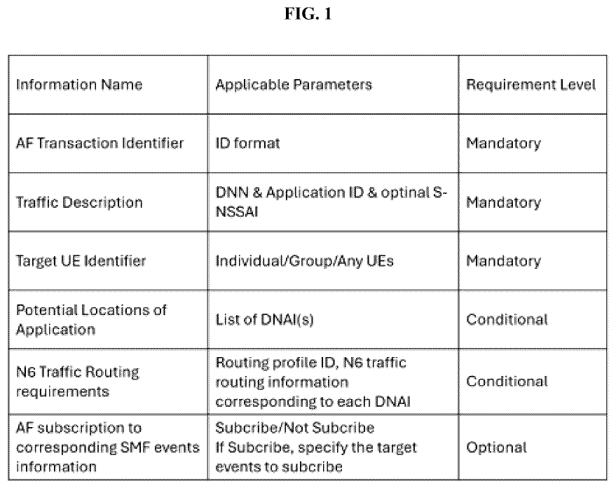

Then, in step 609, as shown in FIG. 1, the NEF provides AF traffic influence request information to the SMF in the Nnef_TrafficInfluence_Create request message 680 in accordance with the standard ETSI 3GPP AF traffic influence procedure for an individual UE. Further, through the NEF, the anycast AF 570 contacts the BSF for information of the PCF controlling a target individual UE. Accordingly, AF traffic influence information is provided to the searched PCF and SMF.

Then, in step 610, the SMF establishes PDU session with a corresponding UPF of an optimal DNAI selected by the anycast AF 570.

During a PDU session, when a change of an optimal DNAI is required on the basis of a network and computing metrics, the DNAI selector 574 of the anycast AF 570 can update a previously created AF traffic influence request.

In step 611 of FIG. 6A, the anycast AF 570 can use the ETSI 3GPP standard AF traffic influence update procedure and update the DNAI of the PDU session for an individual UE.

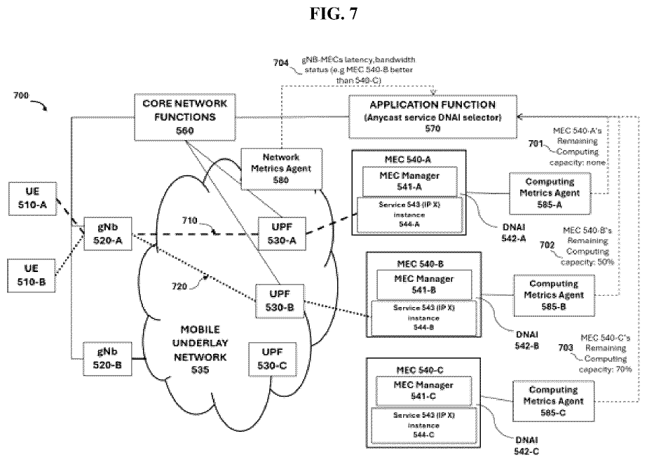

FIG. 7 is a diagram showing a dynamic PDU session establishment process for an anycast service according to the present embodiment.

In this case, simultaneous anycast service UE requests are dynamically routed to different service instance locations on the basis of a current network and computing metrics.

In the scenario 700 shown in FIG. 7, two UEs 510-A and 510-B simultaneously request a predetermined anycast service 543 via the gNB 520-A to the anycast IP address X. The anycast service application function 570 collects current computing and network metrics from the network metric agent 580 and the computing metric agent 585.

In the scenario 700, the anycast AF 570 first determines the service instance location DNAI 542-A for the request from the UE 510-A.

This influences the core network function 560 to set a routing path 710 for the UE 510-A to access the service instance 544-A at the MEC 540-A.

Next, the anycast AF 570 realizes through the computing metric 701 that the MEC 540-A has exceeded its computing capacity, and the MEC 540-B and the MEC 540-C realize through the computing metrics 702 and 703 that they still have computing capacity sufficient to serve the new UE request.

At the same time, the anycast AF 570 realizes through the network metric 704 that the latency and bandwidth status from the gNB 520-A to the MEC 540-B are better than those of the MEC 540-C. Accordingly, the anycast AF 570 determines the service instance location DNAI 542-B for the request from the UE 510-B. This influences the core network function 560 to set a routing path 720 for the service instance 544-B at the MEC 540-B.

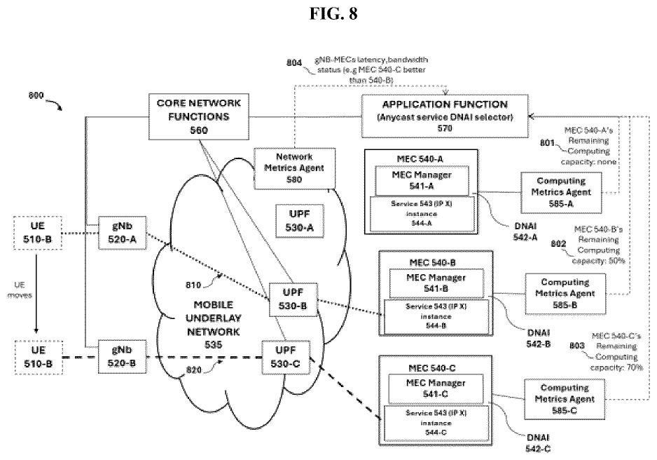

FIG. 8 a diagram showing another exemplary scenario applying the method according to the present embodiment.

In the scenario 800 shown in FIG. 8, the anycast service dynamic PDU session establishment method is applied for traffic steering of the UE that has moved to a new location.

In the scenario 800, the UE 510-B is connected to the gNB 520-A and requests the anycast service 543. The request is serviced by the service instance 544-B at the MEC 540-B through a routing path 810 via the UPF 530-B.

Thereafter, the UE 510-B moves and connects to the gNB 520-B. The core network function 560 notifies user mobility information to the AF 570 and waits for service instance location decision.

The anycast AF 570 learns the current computing and network state through the items of information 801, 802, 803, and 804. The MEC 540-C has the most remaining computing capacity and the best latency and bandwidth state.

Accordingly, the anycast AF determines the service instance location DNAI 542-C for the UE 510-B after moving to and connecting to the gNB 520-B. The core network function sets up a new corresponding routing path 820 to allow the UE 510-B to access the anycast service 543.

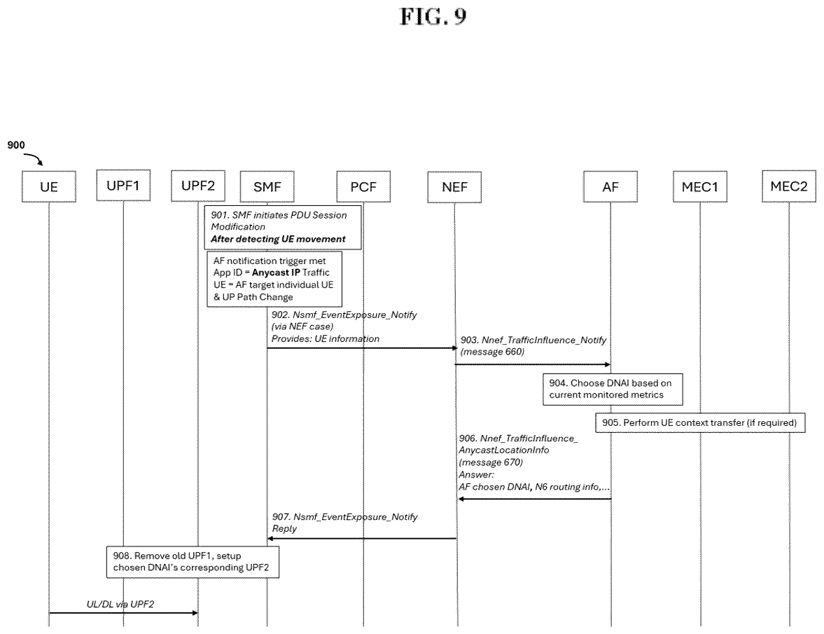

FIG. 9 is a diagram illustrating a dynamic PDU session establishment procedure for an anycast service in the case of UE mobility.

In step 901, the SMF detects that a UE moves to and connects to a new gNB and starts a PDU session update procedure. Sensing of UE movement triggers AF user plane path change event subscription in the previously configured AF traffic impact request for an individual UE in step 606 of FIG. 6A.

Then, in step 902, the SMF exposes UE information to the NEF.

In step 903, the NEF delivers the information exposed by the SMF to the anycast AF 570 via the message 660.

In step 904, the anycast AF 570 determines an optimal service instance location DNAI for the UE after movement on the basis of the current computing and network state information and UE location information from the SMF.

In step 905, depending on the target service type (stateful or stateless service), the anycast AF 570 contacts the current service MEC 1 and the newly selected MEC 2 in the request to perform the UE context transfer.

Then, in step 906, the AF responds to a SMF notification using the corresponding N6 routing traffic toward the selected DNAI and the service instance of the MEC 2.

The NEF delivers this response to the SMF in step 907.

In step 908, the SMF performs UPF reconfiguration. The UPF for the UE request is changed to a UPF2. After this step, uplink and downlink traffic are steered to a new service instance location via the UPF2.

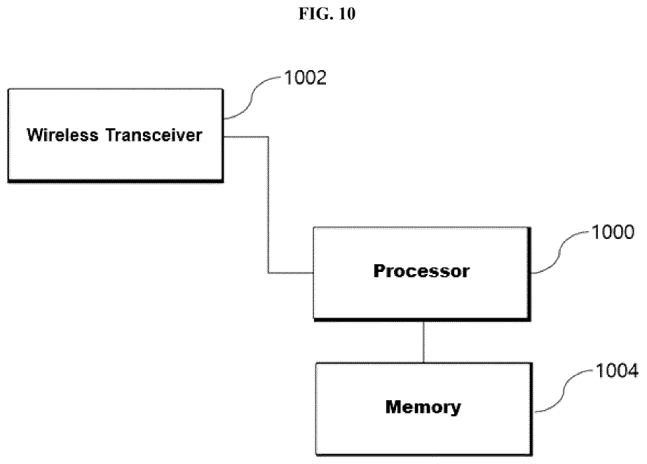

FIG. 10 is a diagram showing the detailed configuration of user equipment according to the present embodiment.

As shown in FIG. 10, UE according to the present embodiment may include a processor 1000, a wireless transceiver 1002, and a memory 1004.

In this case, the processor 1000 may include a central processing unit (CPU) that can execute computer programs, or other virtual machines.

The memory 1004 may include a nonvolatile storage device such as a fixed-type hard drive or a detachable storage device. The detachable storage device may include a compact flash unit, a USB memory stick, etc. The memory 1004 may also include a volatile memory such as various random access memories, and may be defined as a computer-readable recording medium.

The wireless transceiver 1002 transmits/receives wireless signals through one or more antennas under the control by the processor 1000.

In the memory 1004 according to the present embodiment, program instructions for providing an anycast service are stored, and the processor 1000 executes the program instructions to transmit a PDU session establishment request signal for anycast IP address-based services to a mobile underlay network via the wireless transceiver 1002.

Further, the processor 1000 controls the wireless transceiver 1002 such that the anycast AF subscribes to a PDU session establishment event exposure notification for traffic targeting an anycast IP address, the SMF determines that an AF notification trigger is satisfied via the anycast IP address and transmits a user plane management event exposure notification message including a UE address and optional UE location information to the anycast AF through the NEF, the anycast AF selects an optimal DNAI for the requested PDU session on the basis of the currently monitored network and computing metrics and the UE location information, and the anycast AF transmits the selected DNAI and routing information to the NEF via a preset message, and packets are transmitted and received with MEC corresponding to the selected DNAI through the transceiver when the SMF completes PDU session establishment by setting a UPF corresponding to the selected DNAI.

The embodiments of the present disclosure described above are for illustrative purposes only, and those skilled in the art, having ordinary knowledge of the present disclosure, will be able to make various modifications, changes, and additions within the spirit and scope of the present disclosure, and such modifications, changes, and additions should be considered to fall within the scope of the following claims.

What is claimed is:

1. A dynamic protocol data unit (PDU) session establishment method for an anycast service, the dynamic PDU session establishment method comprising:
subscribing to a PDU session establishment event exposure notification for traffic targeting an anycast IP address by means of an anycast Application Function (AF);
determining that an AF notification trigger has been satisfied through the anycast IP address, and transmitting a user plane management event exposure notification message including a user equipment (UE) address and optional UE location information to the anycast AF via a Network Exposure Function (NEF) by means of a Session Management Function (SMF) when there is a PDU session establishment request for an anycast IP address-based service of UE;
selecting an optimal Data Network Access Identifier (DNAI) for the requested PDU session on the basis of currently monitored network and computer metrics, and the UE location information by means of the anycast AF;
transmitting the selected DNAI and routing information to the NEF through a preset message by means of the anycast AF; and
completing PDU session establishment by setting a UPF corresponding to the selected DNAI by means of the SMF.

2. The dynamic PDU session establishment method of claim 1, wherein the anycast AF periodically collects network metrics including network status information monitored in a user plane network and service computing metrics including computing resource status information at all controlled available service locations, and registers distribution status of service instances for the anycast service.

3. The dynamic PDU session establishment method of claim 2, wherein the network metrics include latency and bandwidth information collected by monitoring a mobile underlay network, and
the computing metrics include CPU, GPU, and memory usage statuses, and a queue status of service instances of each of a plurality of Multi-Access Edge Computings (MEC) provided for the anycast service.

4. The dynamic PDU session establishment method of claim 1, wherein the SMF transmits the UE address and the optional UE location information to the anycast AF through a Nnef_TrafficInfluence_Notify message.

5. The dynamic PDU session establishment method of claim 1, wherein the anycast AF responds with a Nnef_TrafficInfluence_AnycastLocationInfo message to the user plane management event notification message.

6. The dynamic PDU session establishment method of claim 5, wherein the Nnef_TrafficInfluence_AnycastLocationInfo message includes an AF transaction ID, identification information of the selected DNAI, N6 traffic routing information corresponding to the selected DNAI, and optional uplink traffic buffering requirements.

7. The dynamic PDU session establishment method of claim 1, wherein the anycast AF dynamically changes a service instance location of a session through an AF traffic influence procedure on the basis of metrics collected in real time during an ongoing PDU session.

8. The dynamic PDU session establishment method of claim 7, wherein the anycast AF transmits a Nnef_TrafficInfluence_Create request message to the NEF when it is required to dynamically change the service instance location.

9. The dynamic PDU session establishment method of claim 8, wherein the Nnef_TrafficInfluence_Create request message includes an AF transaction ID, an anycast IP address, UE address, a selected DNAI, corresponding N6 traffic routing information of the selected DNAI, and DNAI change type information.

10. A method of establishing a dynamic PUD session for an anycast service by means of an anycast Application Function (AF), the method comprising:
subscribing to a PDU session establishment event exposure notification for traffic targeting an anycast IP address;
receiving a user plane management event exposure notification message including a UE address and optional UE location information via a Network Exposure Function (NEF) from a Session Management Function (SMF) determining that an AF notification trigger has been satisfied through the anycast IP address in accordance with a PDU session establishment request for an anycast IP address-based service of UE;
selecting an optimal Data Network Access Identifier (DNAI) for the requested PDU session on the basis of currently monitored network and computer metrics, and the UE location information; and
transmitting the selected DNAI and routing information to the NEF through a preset message,
wherein the SMF completes PDU session establishment by setting a UPF corresponding to the selected DNAI.

11. The method of claim 10, further comprising:
periodically collecting network metrics (network status information) monitored in a user plane network and service computing metrics (computing resource status information) at all controlled available service locations; and
registering distribution status of service instances for the anycast service.

12. The method of claim 10, wherein the transmitting of the selected DNAI and routing information to the NEF responds with a Nnef_TrafficInfluence_AnycastLocationInfo message to the user plane management event notification message.

13. The method of claim 12, wherein the Nnef_TrafficInfluence_AnycastLocationInfo message includes an AF transaction ID, identification information of the selected DNAI, N6 traffic routing information corresponding to the selected DNAI, and optional uplink traffic buffering requirements.

14. The method of claim 10, further comprising dynamically changing a service instance location of a session through an AF traffic influence procedure on the basis of metrics collected in real time during an ongoing PDU session.

15. An anycast Application Function (AF) apparatus for an anycast service, the anycast AF apparatus comprising:
a network metric agent collecting network metrics related to a mobile underlay network;
a service repository managing registration and availability of anycast service instances for all Multi-Access Edge Computings (MEC) under control;
a computing metric agent collecting computing metrics of all MEC servers under control; and
a DNAI selector transmitting an AF traffic influence request to a core network function and selecting an optimal Data Network Access Identifier (DNAI) for a requested PDU session on the basis of currently monitored network and computing metrics and location information of UE requesting establishment of the PDU session for an anycast IP address-based service, in response to a user plane management event exposure notification from the core network function in the case of subscribing to a PDU session establishment event exposure notification for traffic targeting an anycast IP address,
wherein the DNAI selector selects the optimal DNAI when receiving a user plane management event exposure notification message including a UE address and optional UE location information from the core network function determining that an AF notification trigger has been satisfied through the anycast IP address.

16. The anycast AF apparatus of claim 15, wherein the network metrics include latency and bandwidth information collected by monitoring a mobile underlay network, and
the computing metrics include CPU, GPU, and memory usage statuses, and a queue status of service instances of each of a plurality of Multi-Access Edge Computings (MEC) provided for the anycast service.

17. The anycast AF apparatus of claim 15, wherein the DNAI selector responds with a Nnef_TrafficInfluence_AnycastLocationInfo message to the user plane management event exposure notification.

18. The anycast AF apparatus of claim 17, wherein the Nnef_TrafficInfluence_AnycastLocationInfo message includes an AF transaction ID, identification information of the selected DNAI, N6 traffic routing information corresponding to the selected DNAI, and optional uplink traffic buffering requirements.

19. The anycast AF apparatus of claim 15, wherein the DNAI selector dynamically changes a service instance location of a session through an AF traffic influence procedure on the basis of metrics collected in real time during an ongoing PDU session.

20. A UE for providing an anycast service, comprising:
a wireless transceiver for transmitting and receiving wireless signals;
a memory storing program instructions; and
a processor executing the program instructions and controlling the transceiver,
wherein the processor
transmits a PDU session establishment request signal for an anycast IP address-based service by connecting to a mobile underlay network through the transceiver, and
performs control such that an anycast Application Function (AF) subscribes to a PDU session establishment event exposure notification for traffic targeting an anycast IP address, a Session Management Function (SMF) determines that an AF notification trigger is satisfied via the anycast IP address and transmits a user plane management event exposure notification message including a UE address and optional UE location information to the anycast AF through a Network Exposure Function (NEF), the anycast AF selects an optimal Data Network Access Identifier (DNAI) for the requested PDU session on the basis of currently monitored network and computing metrics and the UE location information, the anycast AF transmits the selected DNAI and routing information to the NEF via a preset message, and packets are transmitted and received with a Multi-Access Edge Computing (MEC) corresponding to the selected DNAI through the transceiver when the SMF completes PDU session establishment by setting a UPF corresponding to the selected DNAI.
